(19) United States
(12) Patent Application Publication
(10) Pub. No.: US 2012/0005074 A1
(43) Pub. Date: Jan. 5, 2012

(54) INLINE LINK PAYMENT

(75) Inventors: Mohana Krishnan Kothandaraman, Chennai (IN); Sathish Kumar Venkoba Rao, Chennai (IN); Mohanasivam Umapathy, Chennai (IN)

(73) Assignee: eBay, Inc., San Jose, CA (US)

(21) Appl. No.: 12/827,882

(22) Filed: Jun. 30, 2010

(51) Int. Cl. G06Q 20/00; G06F 3/048

(52) U.S. Cl. 705/39; 715/805; 715/808

(57) ABSTRACT

One or more pay links are provided on a content page, where the user can select the pay link to make a payment directly through a payment provider. A window is opened for the payment provider, and the user access a user account. The user makes the payment and returns to the original content page.

### BACKGROUND

1. Field of the Invention

The present invention generally relates to on-line payments and more particularly to payments made from links on an on-line content page.

2. Related Art

On-line articles and content having text are becoming a very popular way for people to read and/or obtain information. One example is the proliferation of on-line books and readers, such as the iPad from Apple, the Kindle from Amazon, and the NOOK eReader from Barnes and Noble. In addition, most computing devices enable the reader to access on-line content and read that content on the device via a display screen.

To provide additional content, on-line content may include links or hyperlinks that allow the reader to be directed or re-directed to sites or content having additional information about the linked word or phrase. Typically, these links are underlined or otherwise highlighted, such that the reader can click or select the link. Upon doing so, the reader is directed to additional content, such as in a new window or page, so that the reader can obtain more information about the word or phrase. One example is a typical Wikipedia definition of a word or phrase, which contains numerous links to words or phrases within the definition. By selecting a specific link, the reader is directed to another page where that word or phrase is defined in more detail by Wikipedia. Hyperlinks may also be associated with images.

Links may also be used by merchants and advertisers to direct readers to sites for purchasing items. For example, a web page that has an article may also have one or more advertisements, such as on a margin of the page. Selecting an advertisement may then direct the reader to a merchant page offering the item in the advertisement. If the reader is interested in purchasing the item, the user can go through a normal checkout process through the merchant page, including making a payment.

Payments can be processed with the aid of an on-line payment provider, such as PayPal, Inc. of San Jose, Calif. Such payment providers can make transactions easier and safer for the parties. However, even with using a payment provider, the reader is inconvenienced by having to leave the original site and go through a process with the merchant for making the purchase before returning back to the original site. In fact, after the merchant transaction, the reader may simply not go back to the original site. Another possibility is that the reader foregoes any purchases while on the original site, resulting in potential lost sales for merchants advertising on the site.

### SUMMARY

In accordance with an embodiment of the invention, links are provided within a web content, such as text, that enable the reader to select the link and make a payment or other financial transaction directly with a payment provider, without having to be re-directed to a merchant site. The reader may simply roll over a link to see a pop-up window on the content site, where the reader can select or click on a button to make a payment. This then takes reader to the payment provider site with certain information already present, such as information about the reader or user and the payment recipient and transaction details. In another embodiment, the reader does not need to go to a separate payment page, but instead processes the payment through a pop-up window on the content page. Thus, the reader may just need to enter a password or other identifier to access the reader's account and confirm a payment. At this time, the reader can be taken back or returned to the content page.

As a result, the reader can make a payment quickly and easily with minimal time spent away from the content page. Links can be for donations, purchases, or other transactions involving a payment, which allows many different types of entities to use these “in-line link payments.” Publishers of content can easily create such links, such as through JavaScript, and payments can be easily split between different parties, such as a merchant or charity and the publisher of the content. In-line can include links that are within text or other areas of a content page.

These and other features and advantages of the present invention will be more readily apparent from the detailed description of the embodiments set forth below taken in conjunction with the accompanying drawings.

### BRIEF DESCRIPTION OF THE FIGURES

FIG. 1 is a flowchart showing a process for making an in-line text payment according to one embodiment;

FIG. 2 is a flowchart showing a process performed by a payment provider for processing an in-line text payment according to one embodiment;

FIGS. 3A to 3E show different exemplary screen shots in various stages of an in-line text payment process according to one embodiment;

FIG. 4 is a block diagram of a networked system used in an in-line text payment flow according to an embodiment of the invention; and

FIG. 5 is a block diagram of a computer system suitable for implementing one or more embodiments of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

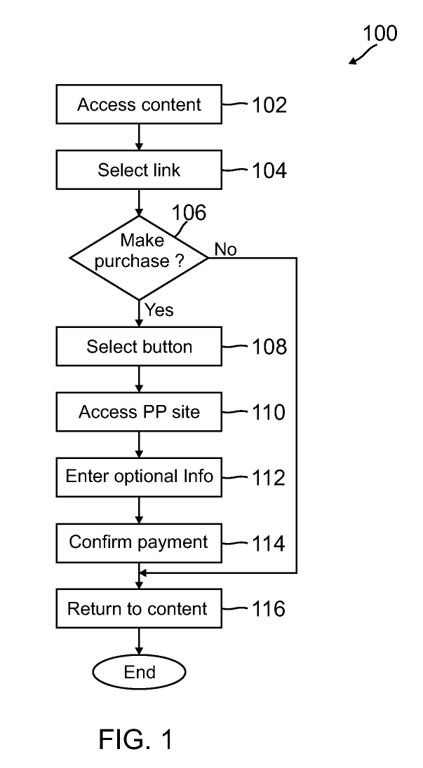

FIG. 1 is a flowchart 100 showing a process for making an in-line payment according to one embodiment of the present disclosure. At step 102, the reader or user access content on a web site. In one embodiment, content can be an article, story, quote, commentary, advertisement, marketing material, or other ways of conveying information that includes text. In another embodiment, non-textual content may also be included, such as images. The user may access the content through a search on an Internet browser on the user's computing device or other computing device. Computing devices include, but are not limited to, smart phones, PCs, laptops, tablets, and the like.

Once the content is accessed, the user may view the content on the device, such as via an LCD display or screen. The content (e.g., hypertext) includes one or more links or hyperlinks, which are references to documents or web pages that the user can directly follow or is automatically directed to. The links may be highlighted, typically by an underline and a color different than the rest of the text, although not all links are highlighted. Links may also be differentiated from text in that a link will change, such as a different color or some other visual on the screen, when a cursor is moved over it. The cursor may also change from an arrow to a hand to indicate an active link.

At step 104, the link is selected. This can be accomplished by clicking on the link, tapping on the link, or holding a mouse or cursor over the link. Once selected, a window, pop-up, or other means to display the new content or target document appears. For example, selecting the link may cause the target document to replace the document being displayed (i.e., the target replaces the content shown in the current window), the target document may appear in a new window, or the target document may appear in a smaller display overlying the current content.

After the link is selected, the user views the content from the target document. This may include making some payment related to the link. For example, the article may be about a recent natural or man-made disaster, where hyperlinks may be interspersed in the article that allow the reader to make a donation to disaster relief or other charitable donations related to the disaster. In another example, a political ad describing a candidate may have links that enable the reader to donate to the campaign, organizations supported by the candidate, or any other payment related to something in the ad. In yet another example, a merchant or company advertisement may include links that allow the reader to purchase items mentioned or described in the advertisement. Thus, as seen, almost any type of content created by any type of entity or individual.

After viewing the content, a determination is made, at step 106, whether to proceed with making a payment. If no, the user can simply close the document or window, such as by clicking on an “x” on the upper left hand corner of the window or clicking a “close” button. Upon closing the target document, the user is returned to the original content at step 116.

However, if the user decides to proceed with making a payment, the user may select an appropriate button at step 108. The button may be a “Purchase,” “Donate,” “Pay,” or other type of button that indicates to the user a desire to proceed with the payment. Selection, in one embodiment, requires the user to click or tap the button.

Upon selecting the button, the user is directed to a payment provider site. In one embodiment, a new window is opened for the site. In other embodiments, the site may be opened in a new tab, a smaller window overlying the original content page, or a pop-up window on the original content page. The user then access the payment provider site at step 110. This may include entering a password or PIN for the user's account with the payment provider. If the username for the account is not provided (such as through information received by the payment provider through the user device), a username or email address may also be requested for entry by the user.

Note that if the user does not have an account with the payment provider, the user may be taken to a page where the user can sign up for an account. This may include opening a new window for the payment provider site, which may request specific information about the user. In one embodiment, the information includes some combination of the user's name, billing address, mailing address, credit card information, bank account information, user name, and password or PIN. Also, if the recipient of the payment does not have an account with the payment provider, the payment provider may notify the intended recipient that a payment is waiting and for the intended recipient to create an account with the payment provider to retrieve the payment. Alternatively, the payment provider may transfer the payment to an account held by a third party, such as a bank.

Optionally, the user may be requested to enter additional information at step 112. For example, the user may be asked to enter a payment amount. The user may also have the option of changing the payment amount if one was pre-filled on the page. Other information may also be requested, such as recipient, user, and/or transaction details.

If the payment provider determines that the payment can be approved, the user is presented with a new screen that allows the user to confirm the payment. The determination can include verifying the user name and/or password is correct and the user has sufficient funds or is within the user limit to make the payment amount.

Once presented with a confirmation page, the user can confirm the payment at step 114, such as by selecting a “confirm,” “pay,” or other similar button or link on the page. When the payment provider receives this confirmation, the payment is processed, e.g., a user account is debited and the amount credited or transferred to a recipient account. The recipient account information may be contained or obtained from the link in the original content transmitted to the payment provider when the user goes through the payment process described above.

After payment, the user is returned to the original content site at step 116. The user may manually exit or close the payment window or select a link in the payment window. In another embodiment, after payment is processed, the payment window may automatically close and return the user to the original content site or page. Communication of the above information may be by any means, such as through the Internet, Bluetooth, NFC, or a wired connection, using suitable components such as antennas and processors.

As a result, the user can easily make a payment from a content site directly through a payment provider site without having to go through a merchant or retailer site. The user can then quickly return to the original content.

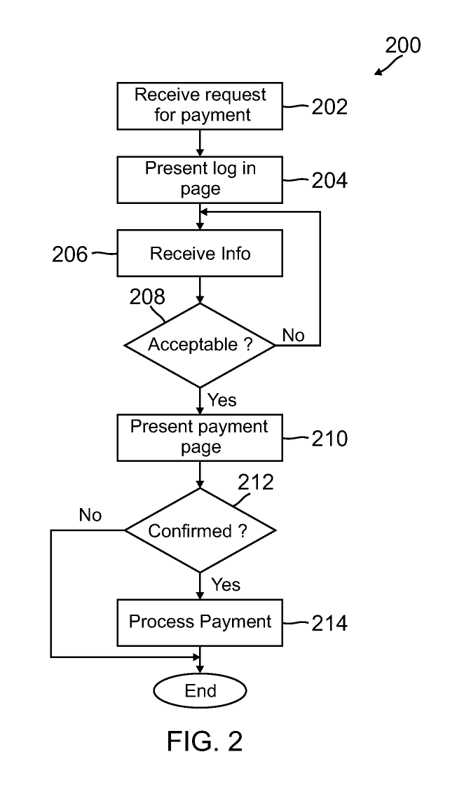

FIG. 2 is a flowchart 200 showing steps performed by a payment provider to process an in-line payment, according to one embodiment. At step 202, the payment provider receives a request for payment, such as when a user selects a hyperlink from a content page and then a button to proceed with the payment, as discussed in FIG. 1. The request may include information about the recipient of the payment as well as the sender of the payment (e.g., the user). The information may be sufficient for the payment provider to determine whether the sender and/or the recipient have accounts with the payment provider and to access relevant account information.

Next, at step 204, the user is presented with a log in page for the payment provider. The page can be opened from a new window (e.g., a pop-up window) or tab, where the window can be a small window overlaying a portion of the original content page. The page may include fields for the user to enter information, such as a password or PIN. The user account name or identifier may be already filled in by the payment provider, or the user may be asked to enter that as well. Other types of information may include the amount of payment.

After the user enters the requested information, the information is received by the payment provider at step 206, such as when the user selects a “continue” or other type of button or link. The information may be transmitted from the user device to a server of the payment provider through any suitable means, including wired and/or wireless communication systems. Once received, the payment provider process the information to determine, at step 208, whether the received information is acceptable. The payment provider may compare the password or PIN with what is expected for the user. The payment provider may also determine whether the indicated payment amount is within limits set for the user.

If, for whatever reason, the payment provider cannot confirm the user, authorize the payment amount, or otherwise confirm the transaction, the payment provider may ask the user to enter information again, which is received at step 206. However, if the received information is acceptable (e.g., recognized password matched with the user identifier), the payment provider presents a payment page to the user at step 210. This page may include details of the payment, along with a button or link that allows the user to confirm the information and/or payment.

If the payment provider does not receive a confirmation from the user, as determined at step 212, the payment may be canceled and the user returned to the original content site. However, if the payment provider receives a user confirmation, the payment provider processes the payment at step 214. For example, the payment provider may deduct the payment amount from the user account and transfer that amount to a recipient account. The payment provider may also notify the recipient and/or user that the payment has been made.

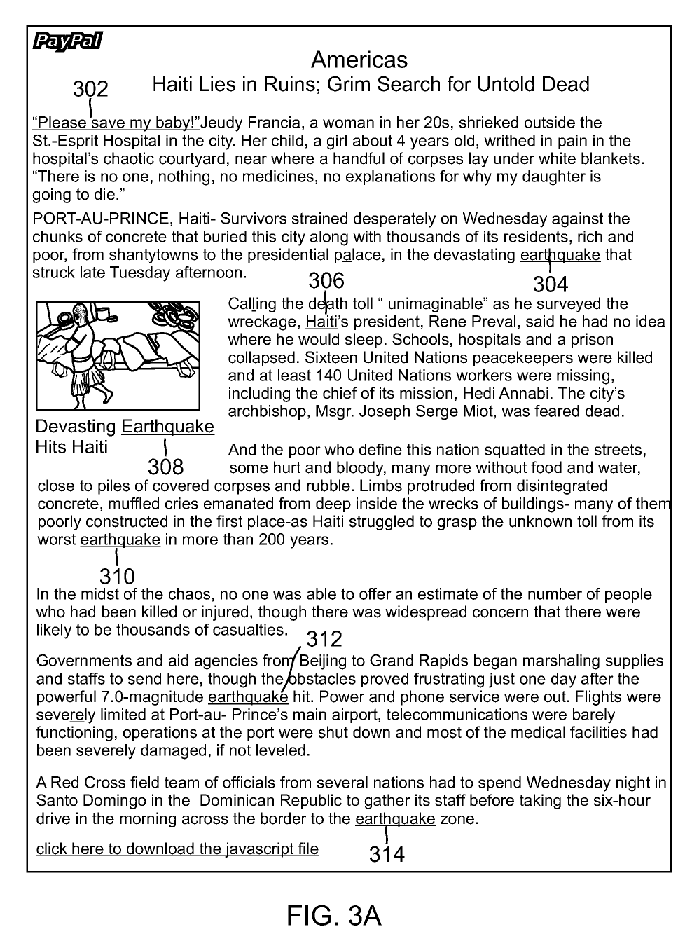

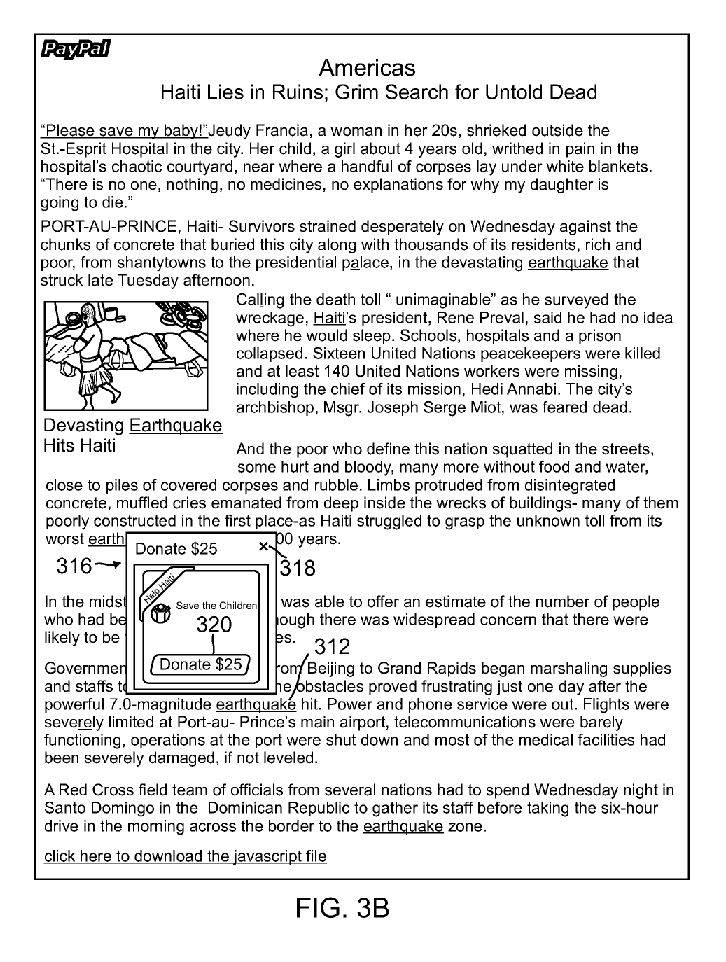

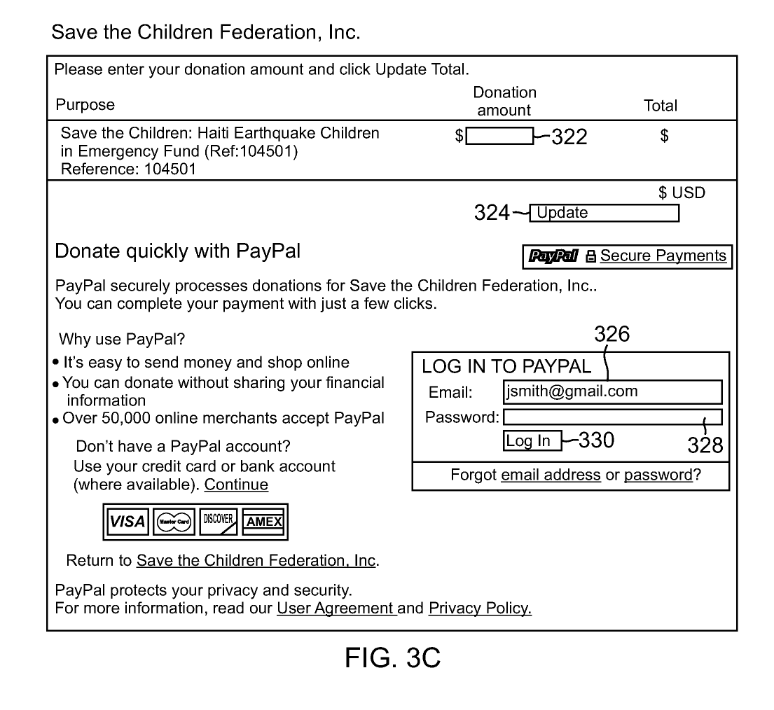

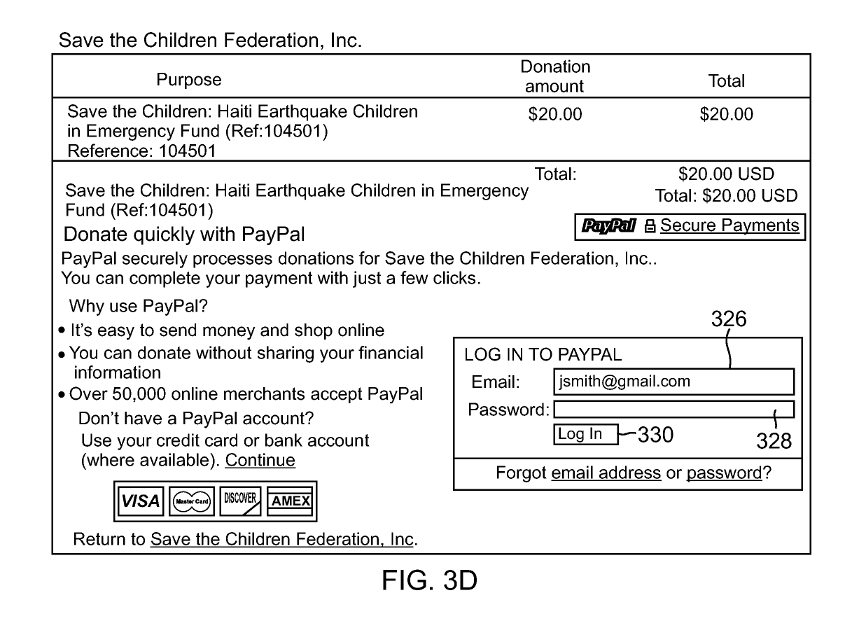

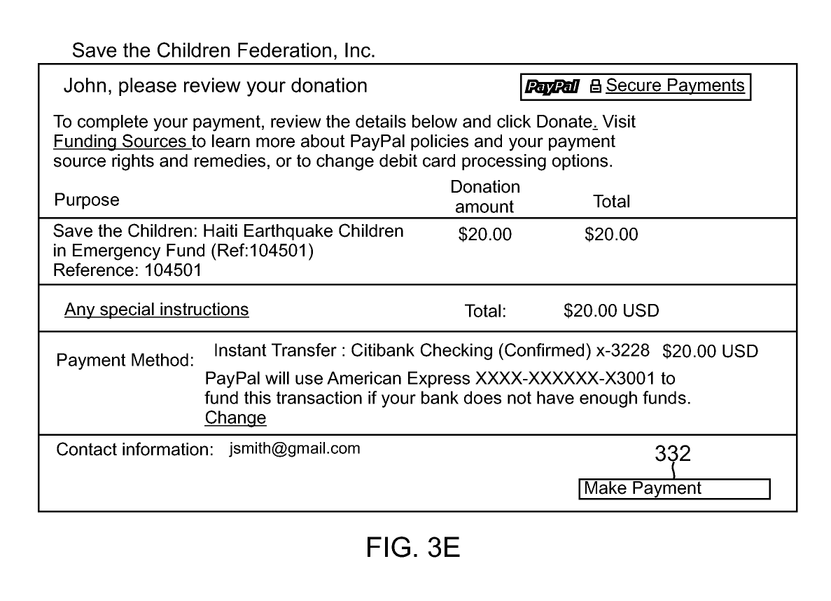

FIGS. 3A to 3E are exemplary screen shots a user sees when making an on-line text payment according to one embodiment. FIG. 3A shows a web page having content, where the content is an article about an earthquake in Haiti, published by the New York Times. The text has seven links or hyperlinks 302, 304, 306, 308, 310, 312, and 314. Note that in this example, the hyperlinks are all text, but they can be in other forms, such as images or symbols. Any number of links can be included and in any combination of different forms.

FIG. 3B shows a pop-up window 316 over the original content when the user places a pointer or mouse over link 312. Window 316 allows the user to donate $25 to “Save the Children,” where window 316 has an “x” 318 to close the window and a button 320 to proceed with the donation. Window 316 may also disappear or close if the user moves the mouse or cursor away from link 312. Note that different links may have different target windows, some of the same target windows, or all the same target windows. This enables a content site to give the reader multiple payment opportunities.

FIG. 3C shows a screen shot when the user selects button 320 in FIG. 3B. The screen shot is from a payment provider site (here PayPal) that includes an amount field 322, an update button 324, a user identifier field 326, a password field 328, and a log in button 330. In this example, amount field 322 is empty, which the user fills in; however, in other embodiments, amount field 322 can be automatically filled in, such as with the $25 amount noted in window 316 of FIG. 3B. Also, in this example, user identifier field 326 is automatically filled in by the payment provider, which in this case is the user's email address. In other embodiments, user identifier field 326 may ask for a user name, phone number, or other identifier. Note that the user sees information about the payment on the screen as well. Here it is “Save the Children: Haiti Earthquake Children in Emergency Fund.”

FIG. 3D shows a screen shot after the user enters an amount in amount field 322 and selects update button 324 in FIG. 3C. The user sees the total payment entered, along with the currency. However, password field 328 is still empty. In this example, the user is first requested to fill in the payment amount, followed by entering in a password. In other embodiments, information entry can be in different orders. For example, the user may be able to enter the payment amount and password on the same screen, or the user may be asked to log into the account first by entering in the password.

FIG. 3E shows a screen shot after the user has entered a password into password field 328 and selected log in button 330 in FIG. 3D, assuming the log in information is correct. The amount, recipient information, funding source, and other information is shown to the user to review before confirming payment. If the user wants to make the payment, the user selects a payment or donate button 332. Once selected, the payment provider processes the payment. In one embodiment, after confirming payment, the payment provider screen closes automatically, and the user is returned to the original content site. In other embodiments, the payment provider may present a confirmation page to the user before closing, the user may be asked to close the page manually, or the user may be asked to select a link to return to the original content site.

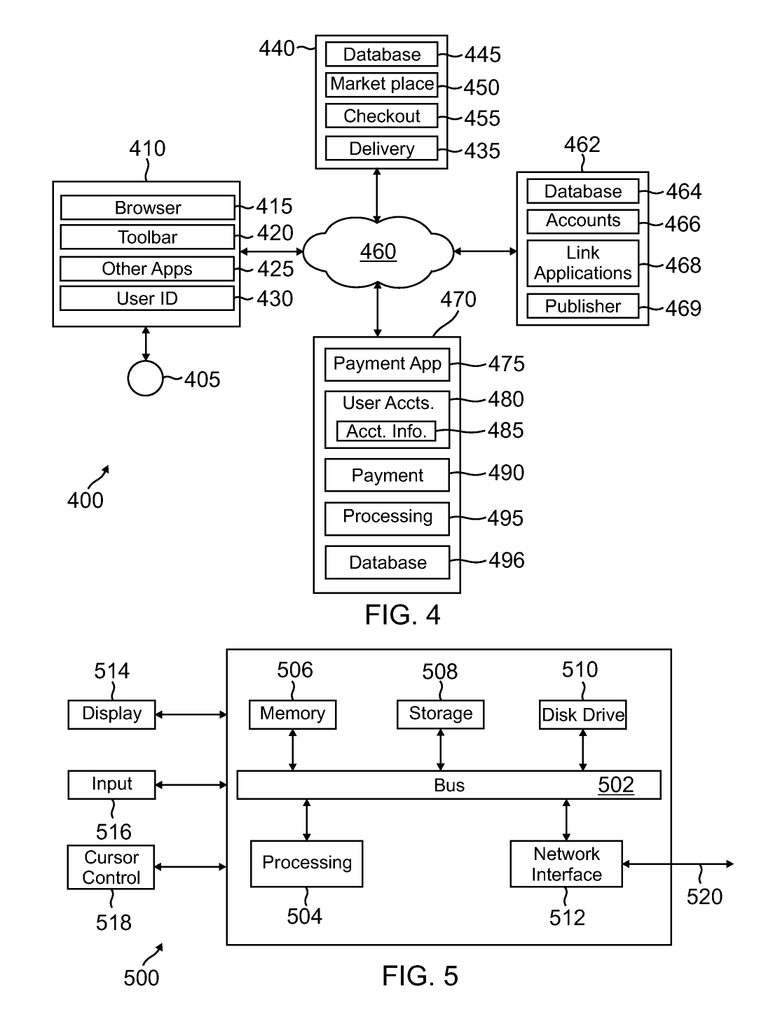

FIG. 4 is a block diagram of a networked system 400 used in an in-line payment flow according to an embodiment of the invention. System 400 includes a client device 410, a merchant server 440, a content provider server 462, and a payment provider server 470 in communication over a network 460. Payment provider server 470 may be maintained by a payment provider, such as PayPal, Inc. of San Jose, Calif.

Client device 410, merchant server 440, content provider server 462, and payment provider server 470 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of system 400, and/or accessible over network 460.

Network 460 may be implemented as a single network or a combination of multiple networks. For example, in various embodiments, network 460 may include the Internet or one or more intranets, landline networks, wireless networks, and/or other appropriate types of networks.

Client device 410 may be implemented using any appropriate combination of hardware and/or software configured for wired and/or wireless communication over network 460. For example, in one embodiment, client device 410 may be implemented as a personal computer of a user 405 in communication with the Internet. In other embodiments, client device 410 may be implemented as a smart phone, personal digital assistant (PDA), notebook computer, and/or other types of computing devices.

As shown, client device 410 may include one or more browser applications 415 which may be used, for example, to provide a convenient interface to permit user 405 to browse information available over network 460. For example, in one embodiment, browser application 415 may be implemented as a web browser configured to view information available over the Internet.

Client device 410 may also include one or more toolbar applications 420 which may be used, for example, to provide client-side processing for performing desired tasks in response to operations selected by user 405. In one embodiment, toolbar application 420 may display a user interface in connection with browser application 415.

Client device 410 may further include other applications 425 as may be desired in particular embodiments to provide desired features to client device 410. In particular, applications 425 may include a payment application, such as described herein for making a payment through a payment provider via a link included in web content. Applications 425 may also include security applications for implementing client-side security features, programmatic client applications for interfacing with appropriate application programming interfaces (APIs) over network 460, or other types of applications. Email applications may also be included, which allow user 405 to send and receive emails through network 460. Client device 410 includes one or more user and/or device identifiers 430 which may be implemented, for example, as operating system registry entries, cookies associated with browser application 415, identifiers associated with hardware of client device 410, or other appropriate identifiers, such as a phone number. In one embodiment, user identifier 430 may be used by a payment service provider to associate user 405 with a particular account maintained by the payment provider as further described herein.

Merchant server 440 may be maintained, for example, by an on-line merchant, non-profit organization, company or other entity or individual developer offering various products and/or services in exchange for payment to be received over network 460, including digital goods and applications. Thus, “merchant” server 440 is not required to be a merchant in the strict sense of the word. Depending on the goods or services offered and the type of “merchant,” components of server 440 may vary, as will be known by those of ordinary skill in the art.

Merchant server 440 includes a database 445 identifying available products and/or services (e.g., collectively referred to as items) which may be made available for viewing and purchase by user 405, including donations by user 405. Accordingly, merchant server 440 also includes a marketplace application 450 which may be configured to provide information over network 460 to browser 415 of client device 410. For example, in one embodiment, user 405 may interact with marketplace application 450 through browser applications over network 460 in order to search and view various products or services identified in database 445.

Merchant server 440 also includes a checkout application 455 which may be configured to facilitate the purchase by user 405 of goods or services identified by marketplace application 450. In this regard, checkout application 455 may be configured to accept payment information from user 405 and/or from payment provider server 470 over network 460.

In one embodiment, merchant server 440 further includes a delivery application 435 which may be configured to deliver a digital or downloadable item to client device 410. For example, if user 405 purchases a downloadable item from merchant, delivery application 435 has the ability to transmit or download the item onto client device 410 after payment is confirmed by payment provider server 470.

System 400 also includes content provider server 462 operated by a content provider, such as a publisher, news service, advertiser, retailer, or any entity or individual that provides content on the Internet to users, such as user 405. Content provider server 462 includes a database 464 that stores content and information about merchants and other entities associated with content and links. Accounts 466 includes account information of advertisers, merchants, and others who may wish to receive payment through links provided through content of the content provider. Link applications 468 allow the content provider to create pay links in their content, such as using JavaScript or other methods. A publisher 469 enables the content provider to create and/or push content, including in-line payment links, to a live site.

Payment service provider server 470 may be maintained, for example, by an online payment provider which may provide payment on behalf of user 405 to the operator of merchant server 440 and/or content provider server 462. Payment provider server 470 includes one or more payment applications 475 which may be configured to interact with client device 410, merchant server 440, and/or content provider server 462 over network 460 to facilitate payments by user 405. In one embodiment, payment provider server 470 may be maintained by PayPal, Inc.

Payment provider server 470 also maintains a plurality of user accounts 480, each of which may include account information 485 associated with individual users or entities. For example, in one embodiment, account information 485 may include private financial information of users of devices such as account numbers, passwords, credit card information, bank information, or other financial information which may be used to facilitate online transactions by user 405, as well as device information from a phone or PC that aids in determining whether a payment request is to be approved. Payment application 475 may be configured to interact with merchant server 440 and/or content provider server 462 on behalf of user 405 during a payment transaction.

In particular, payment service provider server 470 also provides a pay link application 490 which may be configured receive retrieve and process information within a communication when the user goes through a transaction initiated from a pay link through client device 410. A payment processing application 495 may be configured to receive payment request information via the link, process the payment request, and store/retrieve information as needed in a database 496. Processing application 495 may handle splitting payments from user 405, such as allocating a portion of the payment to the merchant and a portion to the content provider. A payment by user 405 through user device 410 may be split in any number of ways with different types and numbers of recipients. Pay link application 490, processing application 495 and/or database 496 may be part of payment application 475.

FIG. 5 is a block diagram of a computer system 500 suitable for implementing one or more embodiments of the present disclosure. In various implementations, the user device may comprise a personal computing device (e.g., a personal computer, laptop, cell phone, PDA, etc.) capable of communicating with the network. The merchant, content provider, and/or payment provider may utilize a network computing device (e.g., a network server) capable of communicating with the network. It should be appreciated that each of the devices utilized by users, merchants, content providers, and payment providers may be implemented as computer system 400 in a manner as follows.

In accordance with various embodiments of the present disclosure, computer system 500, such as a personal computer, smart phone, and/or a network server, includes a bus 502 or other communication mechanism for communicating information, which interconnects subsystems and components, such as a processing component 504 (e.g., processor, micro-controller, digital signal processor (DSP), etc.), a system memory component 506 (e.g., RAM), a static storage component 508 (e.g., ROM), a disk drive component 510 (e.g., magnetic or optical), a network interface component 512 (e.g., modem or Ethernet card), a display component 514 (e.g., CRT or LCD), an input component 516 (e.g., keyboard, keypad, or virtual keyboard), and a cursor control component 518 (e.g., mouse, pointer, or trackball). In one implementation, disk drive component 510 may comprise a database having one or more disk drive components.

In accordance with embodiments of the present disclosure, computer system 500 performs specific operations by processor 504 executing one or more sequences of instructions contained in system memory component 506, such as described above with respect to the user, content provider, merchant, and/or payment provider in FIGS. 1-3. Such instructions may be read into system memory component 506 from another computer readable medium, such as static storage component 508 or disk drive component 510. In other embodiments, hard-wired circuitry may be used in place of or in combination with software instructions to implement the present disclosure.

Logic may be encoded in a computer readable medium, which may refer to any medium that participates in providing instructions to processor 504 for execution. Such a medium may take many forms, including but not limited to, non-volatile media, volatile media, and transmission media. In various implementations, non-volatile media includes optical or magnetic disks, such as disk drive component 510, volatile media includes dynamic memory, such as system memory component 506, and transmission media includes coaxial cables, copper wire, and fiber optics, including wires that comprise bus 502. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by a communication link 520 to the network (e.g., such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 520 and a communication interface 512. Network interface component 512 may include an antenna, either separate or integrated, to enable transmission and reception via communication link 520. Received program code may be executed by processor 504 as received and/or stored in disk drive component 510 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, FIG. 4 discusses a separate merchant and content provider. However, the content provider and the merchant may be the same entity or individual. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method of performing a payment, comprising:
receiving, by a payment provider processor, a request for a payment directly from a user accessing a link from a content page;
presenting the user with a payment page;
receiving information from the user through the payment page; and
processing the request based on the information.

2. The method of claim 1, further comprising automatically closing the payment page after the processing is completed.

3. The method of claim 1, wherein the link is in-line with text as part of an article on the content page.

4. The method of claim 1, wherein the request is received when the user selects a portion of a new window resulting from the user accessing the link.

5. The method of claim 4, wherein the new window overlays a portion of the content page.

6. The method of claim 4, wherein the payment page is presented immediately following the user selecting the portion of the new window.

7. The method of claim 4, wherein the portion is a button.

8. The method of claim 1, wherein the payment page comprises a log in field and a payment amount field.

9. The method of claim 8, wherein the log in field comprises a user identifier field and a password field.

10. The method of claim 9, wherein the user identifier field is automatically filled in by the payment provider.

11. The method of claim 1, wherein the user returns to the content page after the processing is completed.

12. The method of claim 1, wherein the link comprises a word, phrase, symbol, or image.

13. The method of claim 1, wherein the payment page is a pop-up window on the content page.

14. A machine-readable medium comprising a plurality of machine-readable instructions which when executed by one or more processors of a server are adapted to cause the server to perform a method comprising:
receiving a request for a payment directly from a user accessing a link from a content page;
presenting the user with a payment page of a payment provider;
receiving information from the user through the payment page; and
processing the request based on the information.

15. The machine-readable medium of claim 14, wherein the method further comprises automatically closing the payment page after the processing is completed.

16. The machine-readable medium of claim 14, wherein the request is received when the user selects a portion of a new window resulting from the user accessing the link.

17. The machine-readable medium of claim 16, wherein the new window overlays a portion of the content page.

18. The machine-readable medium of claim 16, wherein the payment page is presented immediately following the user selecting the portion of the new window.

19. The machine-readable medium of claim 14, wherein the payment page comprises a user identifier field and a payment amount field and wherein the user identifier field is automatically filled in by the payment provider.

20. The machine-readable medium of claim 14, wherein the user returns to the content page after the processing is completed.

21. An on-line payment system comprising:
means for receiving a request for a payment directly from a user accessing a link from a content page;
means for presenting the user with a payment page of a payment provider;
means for receiving information from the user through the payment page; and
means for processing the request based on the information.
